(19) United States
(12) Patent Application Publication
(10) Pub. No.: US 2006/0288158 A1
(43) Pub. Date: Dec. 21, 2006

(54) Interface system of a serial advanced technology attachment (SATA) having speedy data access function and method thereof

(76) Inventors: Tse-Hsine Liao, Taipei (TW); Ju-Yi Hung, Taipei (TW)

Correspondence Address: HARNESS, DICKEY & PIERCE, P.L.C., P.O. BOX 8910, RESTON, VA, 20195, US

(21) Appl. No.: 11/152,344

(22) Filed: Jun. 15, 2005

(51) Int. Cl. G06F 13/00

(52) U.S. Cl. 711/113

(57) ABSTRACT

An interface system of a serial advanced technology attachment (SATA) having speedy data access function and method thereof, wherein the memory in the system may be expanded by the user, which is used as the buffer or cache between the SATA device and the south-bridge chip. The data storage destination is determined according to the degree of occupancy of the control module, as such achieving the purpose and effectiveness of increasing the speed of data access.

### BACKGROUND OF THE INVENTION

1. Field of the Invention

The invention relates to a system and method for the control and management of a Serial Advanced Technology Attachment (SATA) Interface, and in particular to the system and method which can be used to achieve the speedy access of the stored data by making use of a memory having its capacity expansion desired and decided by the user, in addition to/in corporation with the South-Bridge chip.

2. Related Art

From the beginning of the computer age, the advancement of the operation technology of the computer has made tremendous progress following Moore's Rule. The overall progress of the computer performance is not only dependent on the operation speed of the central processor unit, the data transmission speed of the input/output device and the data bus must also be increased correspondingly to match the increase of the operation speed of the CPU. In this regard, the maximum data transmission speed of the conventional Advanced Technology Attachment (ATA) can reach only 133 MB/sec, which apparently is not capable of catching up with the data processing speed of the CPU. To solve and overcome this problem, a new type of communication interface of the SATA has been developed in recent years, of which the data transmission speed can reach 150 MB/sec, and concerning SATAII, the data transmission speed can reach as high as 300 MB/sec.

Though this technology can be utilized to raise the efficiency and effectiveness of the computer, yet unfortunately, the basic structure and operation methodology of the SATA interface are entirely different from those of the conventional ATA interface, namely, it can't be used to raise the overall speed of the computer through upgrading by making use of the firmware, or simply by the disposition of the peripheral device of a SATA input/output interface. Instead, the original main-machine board must be replaced for a new main-machine board having a SATA interface thus realizing the speed increase. However, by doing so, it does not contribute to any economic benefit of the system, especially to the user of the newly acquired computer system.

Through the utilization of the SATA interface, not only the speed of data transmission is increased significantly, but it also offers more efficiency and convenience in that it is not required to shut down the main power supply before replacing the peripheral equipment as is done with the conventional ATA interface in the prior art. Due to the rearrangement of the data transmission wire and the power wire of the SATA, not only its pin number is decreased, thus the width of the bus is reduced, but the internal circulation of heat dissipation in the computer main frame is also improved. Besides, the distance of the allowable data transmission of the bus is increased. Furthermore, it offers the function and the benefit of ‘hot plug & play’ at any time.

Though the interface of the Universal Serial Bus is also provided with the hot plug & play function, regarding the data transmission speed and the power supply stability, though it is convenient to use, yet it is only suitable for use in the peripheral devices which require less driving power and less data transmission speed, such as, the card reader, the scanner, the printer, the portable disk, and the web cam. Yet for the outside disposed disk driver and the burning machine, especially the DVD burning machine which has been rapidly replacing the CD-R burning machine, the data transmission speed and the driving power provided through the USB interface are apparently insufficient. In the event of power supply instability, it would shut the computer power down while reading the data, and in more serious conditions, it would even lead to the damage of the peripheral devices.

For the above reasons, it is apparent that the SATA interface is more suitable for use as the interface for connecting to the peripheral device, thereby the various manufacturers have dedicated their effort in the research and development of the expansion card used for the SATA interface. Its advantage is that the SATA device can be made operational just by plugging it onto the expansion card, thus the users are not required to replace the entire main-machine-board. In addition, the expansion card can not only be used to connect to the SATA interface which is connected to the inside of the computer main frame, some of the expansion cards are provided with the insertion slots for connecting to the outside device, so that the user may realize the hot plug & play with ease. Moreover, the chipsets made by some of the manufactures are provided with the RAID function, as such raising the data transmission speed and enhancing the safety and integrity of the stored data.

However, presently, the operation speed of the central processor unit and the data transmission speed of its memory have reached at least 533 MB/sec, their faster new versions are still to be announced pretty soon. In this situation, if only one SATA is utilized, even the data transmission speed of the SATA II is only capable of reaching 300 MB/sec, thus its data read/write speed can not catch up with the data processing speed of the central processor unit, thereby it is not able to achieve the optimized operation of the computer. On the contrary, due to the limited data processing speed of the CPU and limited data storage capacity of the computer memory, thereby in the event that in the original arrangement only one SATA is inserted on the expansion card, and due to the fact that the SATA can be hot plug & play through the expansion card, for expansion purpose, 3 more disk drives may be added and connected to 3 additional SATA interfaces through the expansion card, so they can be organized into a disk array of RAID 0,1,or 5 to read/write data simultaneously, and theoretically it may reach the data transmission speed of as high as 1.2 GB/sec. Meanwhile, if the CPU has to execute other indispensable tasks as required by the computer, then the processing speed of the CPU is apparently falling far behind this speed. As such, the functions and the capacity of the SATA may not be fully utilized, thus the maximum efficiency and the effectiveness of the entire computer may not be realized.

### SUMMARY OF THE INVENTION

In view of the above-mentioned problems and shortcomings of the prior art, the object of the invention is to provide a Serial Advanced Technology Attachment (SATA) interface system and method for speedy access of the stored data, including: a connection module, which is used to receive the data transmitted from the south-bridge chip; a control module, which is used to determine the storage destination of the received data based on the time occupancy of the CPU and the access speed of the respective SATA; an expansion module, which is provided with a plurality of SATA insertion slots, and is used to connect to the SATA, and a memory module, which is used to serve as the buffer or cache memory between SATA and South Bridge chip. In addition, a battery is provided on this module to keep and maintain the data in the memory during the power-down of the computer.

To achieve the objective of speedy access of the stored data, the method disclosed by the invention includes the following steps: Firstly, when the CPU shows writing the data to the SATA device is needed, the SATA interface system of the invention is utilized to receive the data desired to be stored from the south-bridge chip. Next, it is determined whether the SATA is busy, if the SATA is busy, then the data is stored in the memory module for temporary storage, otherwise, it is stored directly into the SATA device. Then, when a plurality of SATA devices need to provide data to the CPU for processing, the interface system of the invention is used to receive the data desired to be processed from SATA device. Then it is determined if the CPU is busy, if the CPU is busy, the data is stored into the memory module for caching, otherwise, it is transmitted to the south-bridge chip for processing.

Through the application of the additional memory module of the invention, the capacity of the expanded memory required can be determined by the user, therefore, when the CPU or SATA device is busy, said expanded memory may be used for the temporary storage of the data, so that both CPU and SATA device may be used to realize their maximum efficiency, thus there is no need for either one of them to wait or be forced to downgrade its performance just because the other one is busy.

In addition, the memory module is provided with a battery, such, that the memory module may serve as a virtual disk, thus the initialization data required to be used in the power-up of the computer system may be stored therein, and it can be saved if the the computer is shut down. During the next ‘power-up’ of the computer system, the initialization data set and saved by the Operation System in the previous ‘power-down’ is loaded in from the memory module, so there is no need to read in the data from the SATA device all from the start, thus the ‘power-up’ speed of the computer system can be increased significantly.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below, which is for illustration only and thus is not limitative of the present invention, wherein:

FIG. 1 is a system block diagram of the interface system of SATA for speedy access of the stored data according to the embodiment of the invention;

FIG. 2 is a flowchart illustrating the process of determining if the SATA device is busy, thus deciding whether to write the data into the memory module or directly into the SATA according to the embodiment of the invention;

FIG. 3 is a flowchart illustrating the process of determining if the CPU is busy, thus deciding whether to write the data into the south-bridge chip or into the memory module according to the embodiment of the invention; and

FIG. 4 is a system block diagram of the interface system of the SATA for speedy access of the stored data according to the embodiment of the invention.

### DETAILED DESCRIPTION OF THE INVENTION

The purpose, construction, features, and functions of the present invention can be appreciated and understood more thoroughly through the following detailed description with reference to the attached drawings.

The invention relates to an interface system of SATA for speedy access of the stored data and the method thereof. In the following description, the various specific details of the invention are described to provide a better and complete understanding of the invention. However, to the person familiar with the art, the invention can be realized without requiring such specific details, or it can be implemented with alternative elements or methods. In certain circumstances, the known methods, procedures, elements, and circuits are not described in detail, so as not to unnecessarily obscure the essence of the invention.

In general, the system of the invention can be integrated directly into the main-machine board of the existing computer system. In addition, the system of the invention can be utilized as a stand-alone SATA expansion device outside box, which is serviceable through a connection wire connected to the SATA device.

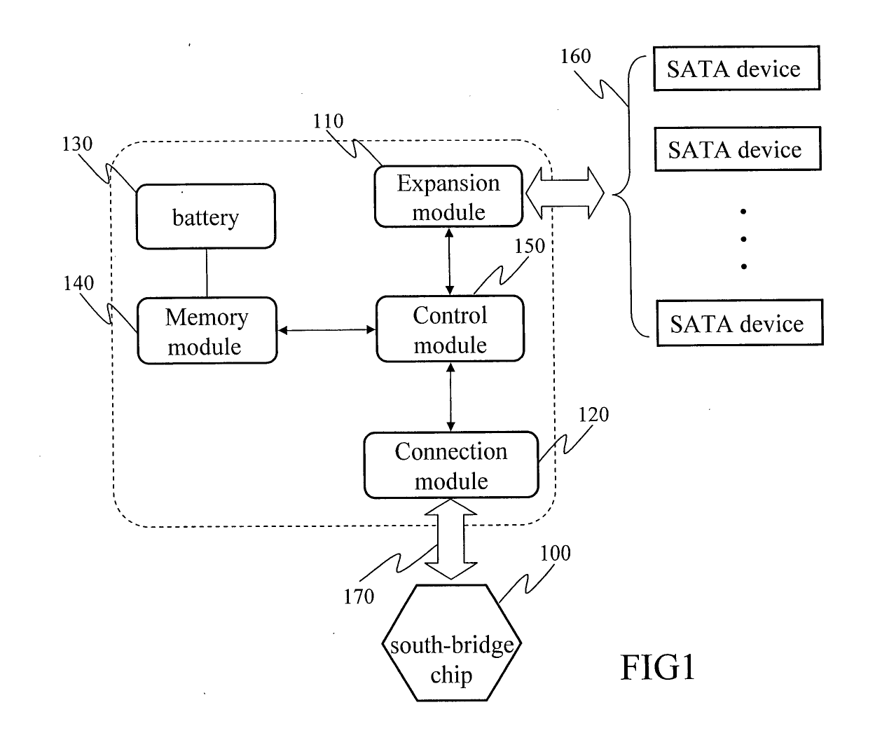

Refer to FIG. 1 for the system block diagram of the interface system of the SATA for speedy access of the stored data according to the embodiment of the invention, including the following devices:

Firstly, a connection module 120, which is connected to the south-bridge chip 100 through the SATAbus 170 for data communication with the south-bridge 100.

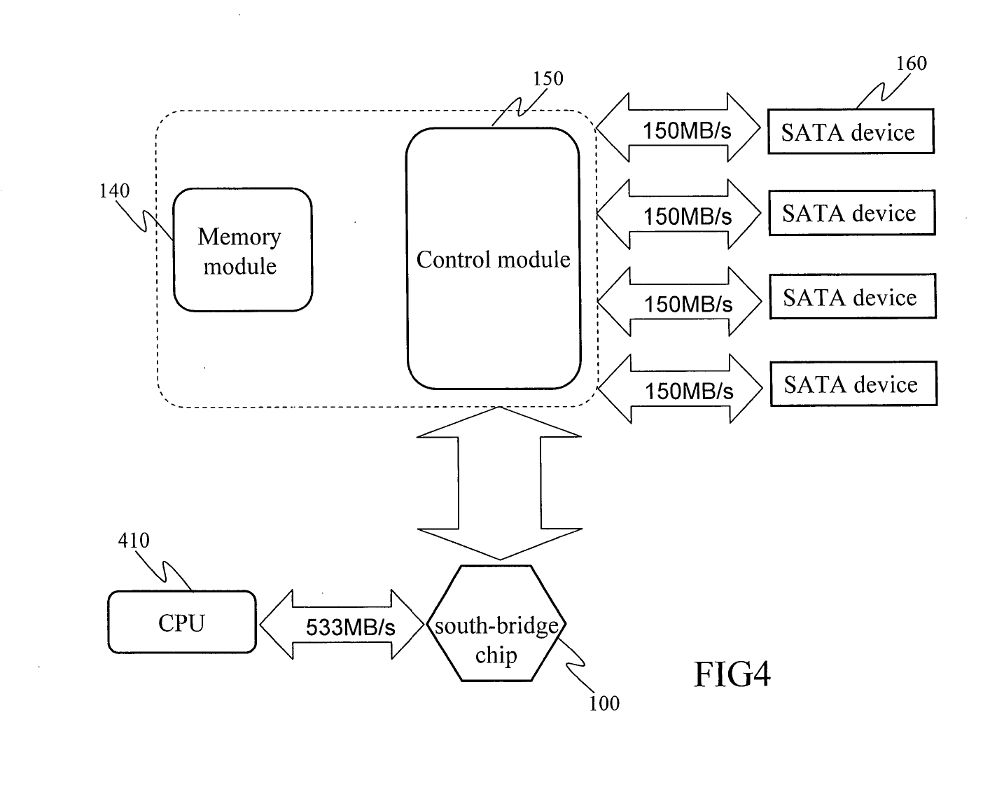

Secondly, a control module 150 which is used to determine the storage destination of the received data, based on the time occupancy of the CPU 410 and the access speed of the respective SATA device 160. Refer to FIG. 4 for the interface system of the SATA for speedy access of the stored data according to one embodiment of the invention. As shown in FIG. 4, since the SATA device 160 is provided with the hot plug & play capability, the data transmission speed of the ordinary SATA is 150 MB/s, while the data transmission speed of SATAII may even reach as high as 300 MB/s, therefore, the addition or removal of a SATA device would affect the operation speed of the entire computer system. Presently, the data processing speed of the mainstay central processing unit 410 is 533 MB/s. In the event that only one SATA device 160 is connected to the computer system and has a maximum data transmission speed of 150 MB/s, then the data transmission speed of 533 MB/s-150 MB/s=383 MB/s is wasted, that is more than ⅔ of the data transmission speed.

The above-mentioned condition can be monitored and corrected by the control module 150 in the following manner: the data transmitted from the south-bridge chip 100 may be directly transmitted to the memory module 140, and it is processed and finished by the central processor unit 410 with the maximum speed, so that it can move on to handle other more urgent tasks. When it is determined by the control module 150 that the SATA device is not busy, the data stored in the memory module 140 is retrieved and written into the SATA device 160. As such, hardware-wise through the application of this control module 150, the processing speed of the central processing unit 410 is increased. Furthermore, to the operation system, since there is no need to take the complicated speed difference relations between the data transmission speed of the SATA device and the data processing speed of the central processing unit 410 into the considerations of the schedule of CPU 410, the speeds of said two devices are viewed and treated as the same, thus simplifying the processing schedule of the operation system.

On the contrary, if originally there is only one SATA device 160 plugged into and added to the expansion card and transmitting data to the central processing unit for processing, then the remaining data processing speed 383 MB/s of the CPU may be used to process other tasks in the procedure. Since the SATA is provided with the hot plug & play capability, if all the four SATA devices 160 are all plugged into the expansion card, then the entire data transmission speed is increased sharply to 150 MB/s×4=600 MB/s, which is more than enough for the remaining data processing speed of the CPU 410 to handle, besides, there are other originally scheduled tasks to be processed, thus the data of said “surplus” data transmission speed of the SATA device 160 is transmitted to the memory module 140 for temporary storage under the control of the control module 150. Then, these data is scheduled by the central processing unit 410 and read sequentially by the south-bridge chip 100 for processing.

Thirdly, an expansion module 110 is provided with a plurality of insertion slots for connecting to the SATA device 160 through a SATA bus 170, and the data transmission rate of the ordinary SATA device is 150 MB/s, and that of SATAII is 300 MB/s. Since the SATA device 160 is provided with the hot plug & play capability, the placement of the insertion slot is not limited to the inner side of the expansion card for the equipment expansion inside the computer system; said insertion slot may also be exposed to the outside of the computer system to facilitate the hot plug & play performed by the user, so that the application and the utilization of the SATA 160 can be more flexible.

Fourthly, a memory module 140, is provided with a plurality of DDR-RAM insertion slots, and is controlled and allocated by the control module 150 according to the data transmission conditions of the SATA device. Since the access of the memory module does not require the mechanical operation as in the case of the motor driven hard disk drive, the accessing speed of the memory module is faster than that of the hard disk drive, as such the memory module can serve as the buffer or cache between the SATA device 160 and the south-bridge chip 100. The capacity of the memory inserted may be chosen by the user, depending on the actual requirements. The larger the capacity of the memory module, the better the access performance of the SATA device 160. When the capacity of the memory module is sufficient, for example 1 GB, then it can serve as a virtual disk. If the Operation System (OS) is provided therein, then there is no need to read the data required for initiation from the disk to this memory module during the ‘power-on’ of the computer system, thereby raising the speed of the power-on procedure. However, the data in the memory would disappear after the ‘power-down’ of the computer system. For this reason, a battery 130 is provided on the expansion card, so that the data in the memory can be kept and maintained by the minute power supplied by the battery 130. In case the rechargeable battery is used, then it is charged automatically when the computer is switched on, and there is no need to worry about the loss of data in the memory due to using up the power.

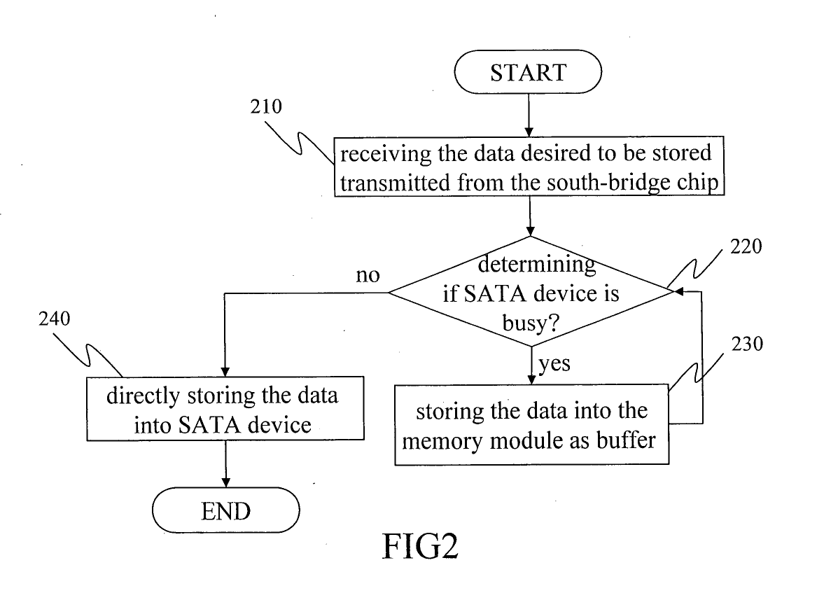

Therefore, in order to make the data transmission speed of the SATA device 160 inserted on the expansion card and the data processing speed of the central processing unit 410 achieve the optimized matching, please refer to FIG. 2, which shows the flowchart of the method according to the embodiment of the invention, wherein is shown that the data is written into the SATA device 160 by the central processing unit 410 and is processed by the control module 150. Firstly, the connection module 120 is used to receive the data transmitted from the south-bridge chip 100 (step 210). Next, it is determined by the control module 150 if the SATA device 160 is busy, based on the number and the data transmission speed of the SATA device 160, the amount of data, and the schedule-order of the operation system (step 220). If the SATA device 160 is busy and is not available for immediate processing, then said data can be stored in the memory module 140 as a buffer for later processing (step 230). If the SATA device 160 is not busy, then said data can be stored directly in SATA device 160 (step 240).

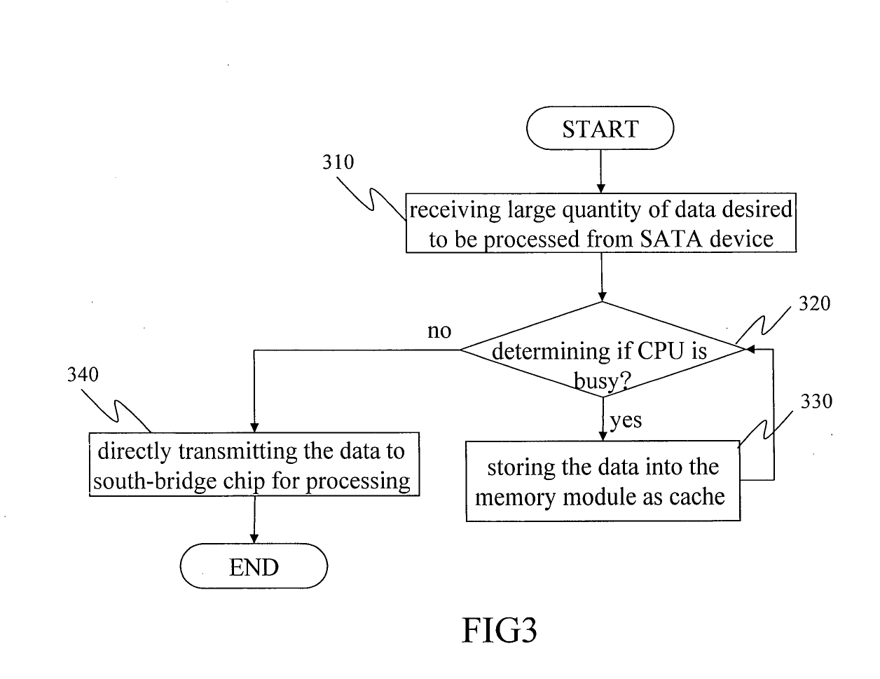

Finally, refer to FIG. 3 for a flowchart of the method of providing the data from a plurality of SATA devices 160 to the central processing unit 41 0 for processing according to the embodiment of the invention. Firstly, the interface system of the invention is utilized to receive the data desired to be processed from the SATA device 160 (step 310). Then, it is determined if the central processing unit 410 is busy, based on the schedule of the operation system, such as the priority of the processing procedure, the ratio of the resources utilization, and the duration of the process operation (step 320). If the central processing unit 410 is busy, or the data transmission speed of the SATA device 160 is faster than the data processing speed of the CPU, then the surplus data derived from the excessive speed is first stored in the memory module 140 as the cache memory (step 330). Then the data processing of the CPU is performed with the same speed as the data transmission speed of the SATA device until the central processing unit 410 is available and has sufficient resources to process the data. Otherwise, the data is transmitted to the central processing unit 410 for processing through the south-bridge chip 100 (step 340).

Knowing the invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1 A SATA interface system having speedy data access function, which is utilized in a computer system comprising:
an expansion module, which is provided with a plurality of SATA insertion slots, and is connected to more than one SATA devices;
a connection module, which is used to receive and transmit a plurality of data from/to a south-bridge chip;
a control module, which is used to determine a storage destination of a plurality of received data based on a degree of occupancy of a central processing unit, and the data transmission speed of said respective SATA device; and
a memory module, which is used as the buffer or cache memory between said SATA devices and said south-bridge chip, or is used as a virtual disk capable of speedy access of the data.

2. The SATA interface system of claim 1, wherein said memory module is provided with a plurality of DDR-RAM insertion slots, which can be used to install the memory of the capacity as required and installed by the user.

3. The SATA interface system having speedy data access function as claimed in claim 1, wherein a battery is disposed and coupled to the top of said memory module, when the computer system is powered-down, which is used to provide the minute power supply to said memory module, thus keeping and maintaining the data inside said memory module.

4. The SATA interface system of claim 1, wherein said memory module is utilized as a virtual disk.

5. The SATA interface system of claim 1, wherein said connection module and said south-bridge chip are utilized to transmit data through a SATA bus.

6. The SATA interface system of claim 5, wherein said SATA bus may be the SATAI or the SATAII version.

7. A SATA interface method having speedy data access function, which is utilized by a central processing unit to write a plurality of data into more than one SATA device, comprising the following steps:
receiving said data desired to be stored from a south-bridge chip;
verifying the busy state of said SATA devices; and
storing said data in a memory module used as a buffer when said SATA devices are in the busy state.

8. A SATA interface method having speedy data access function, which is utilized when it is desired by a plurality of SATA device to provide a plurality of data to the central processing unit for processing, comprising the following steps:
receiving said data desired to be stored from said SATA devices;
verifying the busy state of said central processing unit; and
storing the data in a memory module used as a buffer when said central processing unit is in the busy state.
